(19) United States
(12) Patent Application Publication
(10) Pub. No.: US 2006/0091650 A1
(43) Pub. Date: May 4, 2006

(54) Airbag attachment structure, airbag system and vehicle including the same

(75) Inventor: Kazuki Funakura, Tokyo (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/252,881

(22) Filed: Oct. 19, 2005

(30) Foreign Application Priority Data
Oct. 20, 2004 (JP) 2004-304993

(51) Int. Cl. B60R 21/16

(52) U.S. Cl. 280/732; 280/728.2

(57) ABSTRACT

An airbag attachment structure including an airbag supporting bracket (23), the airbag supporting bracket (23) including: the guide/reinforcement member (33) configured to carry both the guide function of the guide portion (G) and the reinforcement function of the reinforcement portion (R), and cover the circumference of the opening portion (28) of the airbag module (21), leaving an uncovered portion thereon; the partial guide member (34) configured to carry only the guide function of the guide portion (G), which is attached to the uncovered portion; and the partial reinforcement member (35) configured to carry only the reinforcement function of the reinforcement portion (R), which covers the partial guide member (34) from an outside thereof.

### BACKGROUND

1. Field of the Invention

The present invention relates to an airbag attachment structure.

2. Description of Related Art

In a vehicle like a motorcar, an airbag apparatus is attached to the vehicle as a safety system. As such the airbag apparatus there is known an airbag apparatus for a front occupant seat. There is disclosed in Japanese Patent Application Laid-Open No. 2002-220018 an airbag apparatus for a front occupant seat including an airbag module for accommodating an airbag body therein, wherein the airbag body is held on a back surface of an instrument panel, through an airbag supporting bracket.

The airbag supporting bracket includes a guide portion for guiding the airbag body inflated out of an opening portion of the airbag module, a reinforcement portion for reinforcing the guide portion. The reinforcement portion is provided with an attachment portion to be attached to the back surface of the instrument panel.

For example, a conventional airbag supporting bracket is, as shown in FIGS. 5A and 5B, provided with a hollow rectangular prism shaped guide portion 3 including two thin iron panels 1 and 2 which are bent into a square U shape and are combined with each other to form a substantial rectangular shape as viewed from a top plan. Further, the airbag supporting bracket is provided with a substantially rectangular shaped reinforcement portion 8 having a back frame part, two side frame parts 5 and 6 and a front frame part 7 which are combined with each other to surround the guide portion 3. Each of the side frame parts 5 and 6 includes two parts: an upper frame part 9 formed into an L shape having an obtuse angle thereof and both ends thereof turned down as viewed from a side plan; and a lower frame part 10 formed into an L shape having an obtuse angle thereof and both ends thereof turned up as viewed from a side plan. Each of the frame parts composing the reinforcement portion 8 has a thick wall and a substantially oblong card shape, and a side edge thereof is bent into a reinforcement flange according to need. Edges of the back frame part 4 and the front frame part are respectively bent into attachment flanges 13 and 14, which have a plurality of openings 12, 11 to be used for attaching the flanges to the back surface of the instrument panel. Further, the guide portion 3 and the reinforcement portion 8 are jointed by spot-welding, keeping the guide portion 3 bendable.

The airbag body inflated out of the opening portion of the airbag module is guided with the rectangular prism shaped guiding portion 3 so that the airbag body cannot protrude in a lateral direction and presses the back surface of the instrument panel, whereby tearing a door portion formed on the back surface of the instrument panel and unfolding toward a occupant room of the vehicle. The guiding portion 3 includes flexible thin panels 1 and 2 so that influence of the distension of the airbag module can be absorbed when the airbag body is inflated. Further, the reinforcement portion 8 allows the guide portion 3 bowing to a certain degree but reinforces the guide portion 3 to restrain the guide portion 3 from bowing over the certain degree.

In the conventional airbag attachment structure as described above, the airbag supporting bracket is divided into two main parts: the guide portion 3; and the reinforcement portion 8. An entire circumference of the guide portion 3 is made as a flexible structure in order that an attachment portion of the reinforcement portion 8 against the back surface of the instrument panel cannot be broken by the influence of the distension of the airbag module when the airbag body is inflated. However, in case the airbag supporting bracket is divided into the guide portion 3 and the reinforcement portion 8, the structure of the airbag attachment portion must be complicated, giving rise to high cost because of much numbers of parts and welding points. That is, for example, the structure described above requires totally eight pieces of parts: two pieces of the guide portions 3 and six pieces of the reinforcement portion 8. The structure described above further requires 20 points of spot-welding. Also, the complexity of the structure issues another problem that a special design should be made for every vehicle type and such a design must be time/labor-consuming.

Alternatively, in order that the airbag supporting bracket cannot be bowed by the distension of the airbag module when the airbag body is inflated, the stiffness of the airbag supporting bracket may be increased or an ample clearance may be disposed. According to these alternative designs, the airbag supporting bracket becomes heavier/bigger, and thus, it is not practical.

### SUMMARY

The present invention has been made in consideration of above mentioned actualities, thus the present invention provides an airbag attachment structure comprising: an airbag supporting bracket for holding an airbag module to a back surface of an instrument panel, which comprises a guide portion configured to guide tan airbag body inflated out of an opening portion of the airbag module and a reinforcement portion configured to reinforce the guide portion, wherein the airbag supporting bracket further comprises: a guide/reinforcement member configured to carry both a guide function of the guide portion and a reinforcement function of the reinforcement portion, and cover a circumference of the opening portion of the airbag module, leaving an uncovered portion thereon; a partial guide member configured to carry only the guide function, which is attached to the uncovered portion; and a partial reinforcement member configured to carry only the reinforcement function, which covers the partial guide member from an outside thereof.

Preferably, the present invention provides the airbag attachment structure described above, wherein the opening portion of the airbag module has a substantially rectangular shape, wherein the guide/reinforcement member includes: a back plate disposed along a back surface of the opening portion; and both side plates disposed along both surfaces of the opening portion, the back plate and both of the side plates forming a substantially square U shape as viewed from a top plan, wherein the partial guide member includes an impact absorbing plate disposed along a front surface to close an open portion of the substantially square U shape of the guide/reinforcement member, and wherein the partial reinforcement member is a front plate disposed outside of the impact absorbing plate.

These and other objects, features and advantages of the invention will be appreciated upon reading of the description of the invention when in conjunction with the attached drawings, with the understanding that some modifications, variations and changes of the invention could be easily made by the skilled person in the art to which the invention pertains without departing from the spirit of the invention or the scope of the claims.

The present application is based on, and claims priority from, Japanese Patent Application No. 2004-304993, filed on Oct. 20, 2004, the contents of which are hereby incorporated by reference herein in its entirety.

### BRIEF DESCRIPTION OF THE DRAWINGS

For a better understanding of the invention, reference is made to the attached drawings, wherein:

FIG. 1 is a sectional side view illustrating one embodiment of the present.

FIG. 2 is a perspective view of an airbag supporting bracket shown in FIG. 1.

FIG. 3A is a top plan view of the airbag supporting bracket shown in FIG. 1.

FIG. 3B is a side view of the airbag supporting bracket shown in FIG. 1.

FIG. 4 is an exploded view of the airbag supporting bracket shown in FIG. 1.

FIG. 5A is a top plan view showing a conventional airbag supporting bracket.

FIG. 5B is a side view showing a conventional airbag supporting bracket.

### DETAILED DESCRIPTION OF THE PREFERRD EMBODIMENTS

Hereinafter, one embodiment of the present invention is described referring to accompanied drawings.

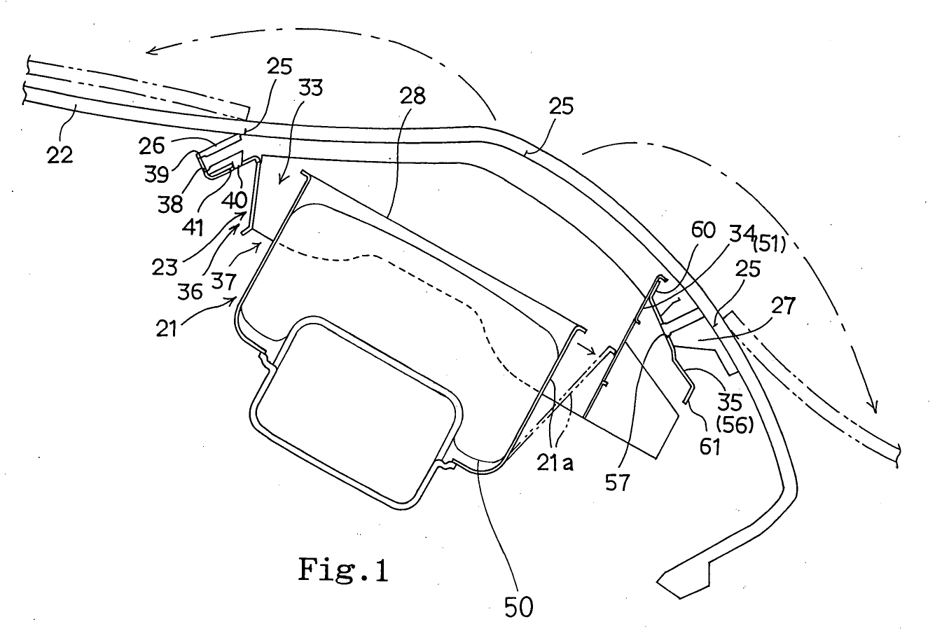

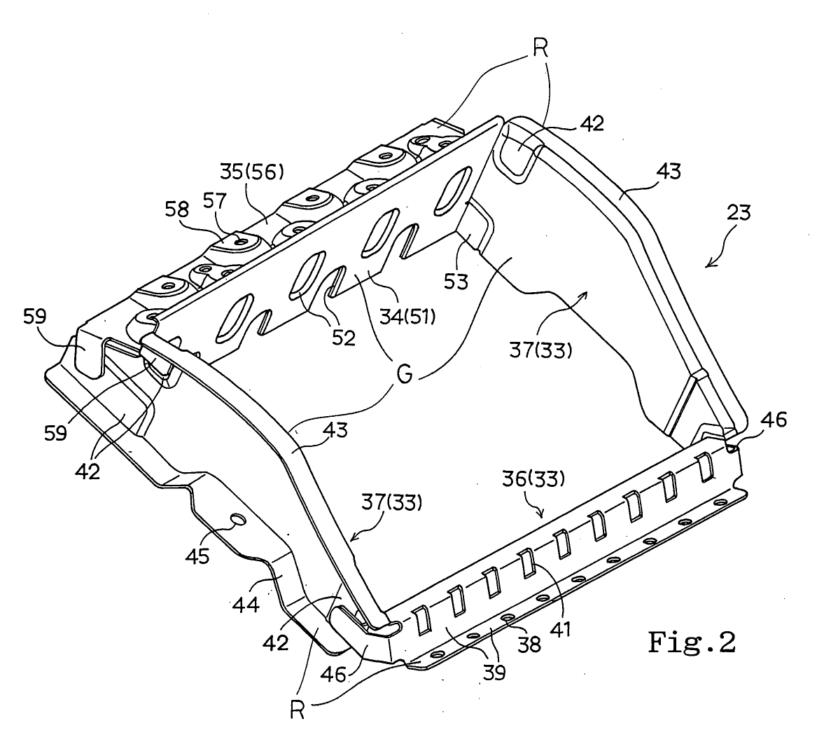

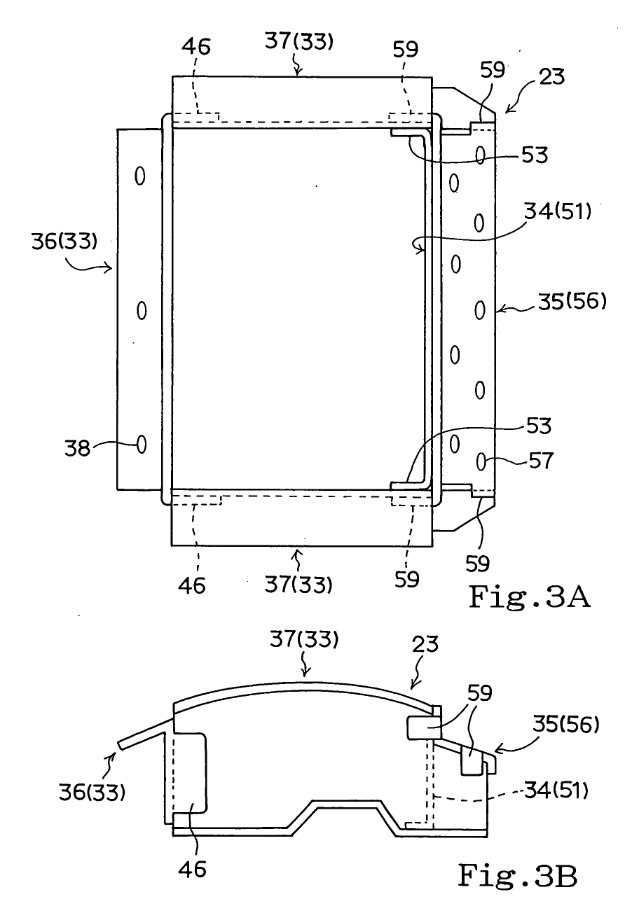

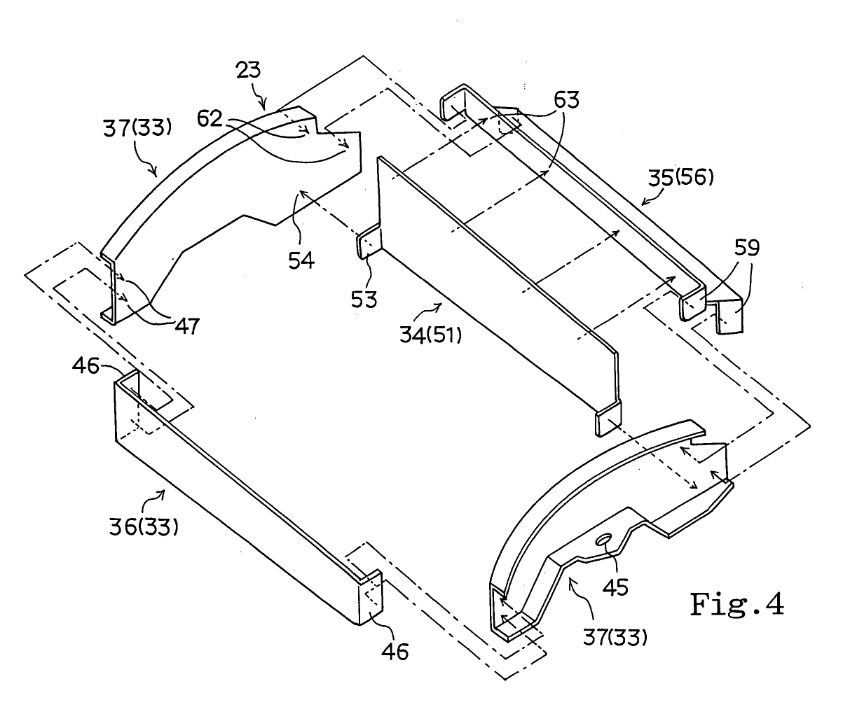

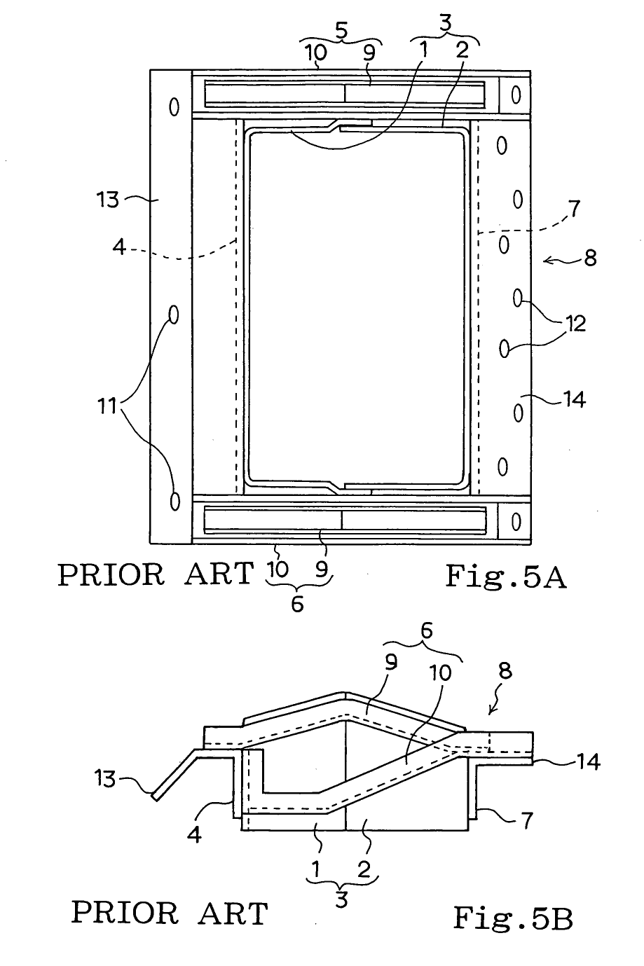

FIGS. 1 to 4 illustrate the embodiment of the present invention.

First, a structure of the embodiment is described below. Generally, an airbag apparatus is employed in a vehicle like a motorcar as a safety system for an emergency. As an example of such an airbag apparatus, an airbag apparatus for a front occupant seat of the present invention is also attached to a vehicle. The airbag apparatus for a front occupant seat is, as shown in FIG. 1, provided with an airbag module 21 accommodating an airbag body 50 therein, wherein the airbag module 21 is attached to a back surface (i.e., a reverse) of an instrument panel 22, being supported with an airbag supporting bracket 23. In this structure, a peripheral surface of the airbag module 21 and the airbag supporting bracket 23 are overlapped with each other in a substantially vertical direction (i.e. a direction in which the airbag body 50 is to protrude), and a predetermined clearance is formed between the peripheral surface of the airbag module 21 and the airbag supporting bracket 23 in a lateral direction. The size of the clearance in the lateral direction is determined so that the airbag body 50 cannot run off a side of the airbag module 21 during inflating.

Sprit lines 25 are formed on a back surface (a reverse) of the instrument panel 22, defining a door portion where the airbag body 50 is to get out of. The split lines 25 may be formed into a square shape, a “U” shape, an “H” shape, etc. as viewed from a top plan. Bosses 26 and 27 to which the airbag supporting bracket 23 is attached may be formed on the back surface of the instrument panel 22 and be disposed close to a periphery of the split lines 23, as need arises. In this embodiment, the boss 26 is disposed along an edge portion of a back of the door portion and the boss 27 is disposed along an edge portion of a front of the door portion (In this description, basically, if no other specific explanation is given, the “back” indicates a remoter side from the front occupant seat relative to the “front”, i.e., the “back” means a front side of the vehicle. Also, the “front” indicates a side closer to the front occupant seat relative to the “back”, i.e., the “front” means a rear side of the vehicle.).

The bosses 26 and 27 are formed extending in a direction substantially parallel to a mold-pulling direction of the instrument panel 22 (i.e., a direction declining toward the back of the instrument panel 22).

The airbag module 21 is disposed at the back surface of the instrument panel 22 but is apart from the back surface, forming a predetermined space between the airbag module 21 and the back surface in the substantially vertical direction (i.e. the direction in which the airbag body 50 is to protrude). A lower portion of the airbag module 21 is attached to a vehicle body side member via a member-attachment bracket (not shown).

The airbag supporting bracket 23 includes a guide portion G for guiding the airbag body 50 inflated out of an opening portion 28 and a reinforcement portion R for reinforcing the guide portion G.

In this embodiment, the airbag supporting bracket 23 carries a guide function of the guide portion G as well as a reinforcement function of the reinforcement portion R. The airbag supporting bracket 23 is provided with a guide/reinforcement member 33 which covers a part of a circumference of the opening portion 28, forming an uncovered portion at the circumference of the opening portion 28.

Further, in this preferred embodiment, the airbag supporting bracket 23 is provided with a partial guide portion 34 carrying only the guide function, attached to the uncovered portion.

Moreover, in this preferred embodiment, the airbag supporting bracket 23 is provided with a partial reinforcement portion 35 carrying only the reinforcement function, which covers/reinforces the partial guide portion 34 from an outside thereof.

Specifically, the opening portion 28 of the airbag module 21 has a substantially rectangular shape as viewed from a top plan.

Corresponding to the above-mentioned structure, the guide/reinforcement member 33 of the airbag supporting bracket 23 is provided with a back plate 36 and both side plates 37. The back plate 36 is disposed along a back surface of the opening portion 28. The both side plates 37 are disposed along two side surfaces of the opening portion 28, respectively. Thus, these plates 36 and 37 form a substantially “square U shape” (i.e., a shape including three linear parts defining an open portion, wherein two of the linear parts perpendicularly extend from both ends of the rest of the linear parts respectively) as viewed from a top plan.

The back plate 36 is formed with a rigid thick plate extending in a substantially lateral direction of the vehicle. A surface of the back plate 36 defines a guide wall extending in the direction in which the airbag body 50 is to protrude (i.e., a direction substantially parallel to a corresponding surface of the airbag module 21 (In this embodiment, an upper end portion of the back plate declines toward a back side.).). The upper end portion of the back plate 36 is bent to form an attachment flange 39 having attachment holes 38 thereon to be attached to the back surface of the instrument panel 22. The attachment flange 39 is bent twice to extend along lower and top end surfaces of the boss 26. On the attachment flange 39, there are formed engagement holes 41 configured to engage with engagement pins 40 downwardly projecting from the lower surface of the boss 26. A lower end portion of the back plate 36 may be bent to form a reinforcement flange, as need arises.

Each of the two side plates 37 is formed with a rigid thick plate extending in a substantially longitudinal direction of the vehicle. Each surface of the side plates 37 defines a guide wall extending in the direction in which the airbag body 50 is to protrude (i.e., a direction substantially parallel to a corresponding surface of the airbag module 21). On surface portions of the side plates 37, there may be formed reinforcement portions 42 consisting of beads, portions bent out of the side plates 37, etc. Upper end portions of the side plates 37 have a substantially mountain-shape, extending along a shape of the back surface of the instrument panel 22. Further, the upper end portions are bent to form reinforcement flange portions 43, extending along the mountain-shape. Lower end portions of the side plates 37 have a substantially hat-shape, and are bent to form reinforcement flange portions 44, extending along the hat-shape. On the reinforcement flange portions 44 having a substantially hat-shape, there are formed attachment holes 45 configured to be attached to a side portion of the airbag module 21.

Both sides of the back plate 36 protrude and are bent to form welding pieces 46 which overlap with the side plates 37. The both sides of the back plate 36 are welded onto the side plates 37 to connect the back plate 36 to the side plates 37.

The partial guide portion 34 of the airbag supporting bracket 23 includes an impact absorbing plate 51. The impact absorbing plate 51 is disposed along a front surface of the airbag module 21, which defines the opening portion 28, to close the open portion of the substantially square U shaped guide/reinforcement member 33 (i.e., the impact absorbing plate 51 is disposed to cover the uncovered portion at the circumference of the opening portion 28).

The impact absorbing plate 51 is formed with a thin plate extending in a substantially lateral direction of the vehicle. A surface of the impact absorbing plate 51 defines a guide wall extending in the direction in which the airbag body 50 is to protrude (i.e., a direction substantially parallel to the corresponding front surface 21a of the airbag module 21). On a surface of the impact absorbing plate 51, there may be formed a bowing-assist/weight-saving portions 52 such as through-holes, slits, etc. Both side ends of the impact absorbing plate 51 protrude and are bent to form welding pieces 53 which overlap with the side plates 37. The welding pieces 53 are spot-welded onto the side plates 37 to connect the impact absorbing plate 51 to the side plates 37 (i.e., totally two points of spot-welding portions 54 are required for both sides). An upper end portion of the impact absorbing plate 51 may be bent, as need arises.

The partial reinforcement portion 35 of the airbag supporting bracket 23 includes a front plate 56 disposed outside of the impact absorbing plate 51.

The front plate 56 is formed with a rigid thick plate extending in a substantially lateral direction of the vehicle. A surface of front plate 56 faces the back surface of the instrument panel 22, being disposed separately from the impact absorbing plate 51. On the surface of the front plate 56, there may be formed attachment holes 57 for attaching the front plate 56 to the bosses 27 on the back surface of the instrument panel 22. On a circumference of the attachment holes 57, a mountain-shaped attachment base protruding upward may be formed by way of out-of-plane bending. Both side ends of the front plate 56 protrude and are bent to form welding pieces 59 which respectively overlap with the side plates 37. The welding pieces 59 are respectively spot-welded onto the side plates 37 to connect the front plate 56 to the side plates 37 (i.e., totally four points of spot-welding portions 62 are required for both sides). A lower end portion of the front plate 56 may be bent to form an reinforcement flange 61, as need arises. Further, an upper edge portion of the front plate 56 is bent to form a flange portion 60. The flange portion 60 is configured to be a welding piece which overlaps the impact absorbing plate 51. The welding piece of the flange portion 60 is spot-welded onto the impact absorbing plate 51 to connect the front plate 56 to the impact absorbing plate 51 (i.e., totally four points of spot-welding portions 63 are required for both sides). A lower edge portion of the front plate 56 may be bent to form a reinforcement flange 61, as need arises.

Hereinafter operations of this embodiment will be described.

When the airbag body 50 in the airbag module 21 is inflated out of the opening portion 28, the airbag body 50 is guided not to get out laterally with the guide/reinforcement member 33 and the partial guide portion 34, and presses the back surface of the instrument panel 22, and then splits the door portion open, inflating toward the occupant room of the vehicle.

When the airbag body 50 inflates out of the airbag module 21, each plane defining the opening portion 28 of the airbag module 21 is bulged as shown by front surface 21a designated by a broken line in FIG. 1. Influence of this bulge is absorbed by deforming the impact absorbing plate 51 as the partial guide portion 34. That is, the impact absorbing plate 51 is configured to be inflexible against the airbag body 50 being inflated. At this time, since the surface of the front plate 56 as the partial reinforcement portion 35 is separated from the impact absorbing plate 51, little influence is exerted on the front plate 56, and thus the attachment portion between the bosses 27 and the attachment holes 57 is protected. Further, the surface of the back plate 36 of the guide/reinforcement member 33 may be formed into an evacuated shape inclining backward (a shape inclining toward an expanding direction of the airbag module) to reduce the influence of the bulge of the back plane of the airbag module 21.

In this embodiment, the airbag supporting bracket 23 comprises: the guide/reinforcement member 33 configured to carry both the guide function of the guide portion G and the reinforcement function of the reinforcement portion R, and cover the circumference of the opening portion 28 of the airbag module 21, leaving an uncovered portion thereon; the partial guide member 34 configured to carry only the guide function of the guide portion G, which is attached to the uncovered portion; and the partial reinforcement member 35 configured to carry only the reinforcement function of the reinforcement portion R, which covers the partial guide member 34 from an outside thereof. Thus, the guide portion G configured to guide the airbag body 50 to the occupant room is a flexible structure in part. Therefore, the influence (input impact) of the bulging of the airbag module 21 that occurs when the airbag body 50 is inflated can be fully/partly absorbed so that the portion for attaching the airbag supporting bracket 23 to the back surface of the instrument panel 22 cannot be broken. That is, since the impact absorbing plate 51 as the partially reinforcement member 35 can be deformed to absorb the input impact, at least the attachment portion to the bosses 27 located on the front plate 56 side, which is a side close to the front occupant seat, can be protected.

Since the guide portion G has the flexible structure in part, the structure thereof is simple comparing to a structure in which an entire inner circumference thereof is flexible. Thus, the number of parts and/or welding spots can be reduced to save cost. Also, the airbag attachment structure can be generalized to vastly reduce the time/effort as to design for every vehicle type.

Specifically, the opening portion 28 of the airbag module 21 has a substantially rectangular shape, and the guide/reinforcement member 33 includes: the back plate 36 disposed along the back surface of the opening portion 28; and the both side plates 37 disposed along the both surfaces of the opening portion 28, the back plate 36 and both of the side plates 37 forming a substantially square U shape as viewed from a top plan. The partial guide member 34 includes the impact absorbing plate 51 disposed along the front surface to close the open portion of the substantially square U shape of the guide/reinforcement member 33. The partial reinforcement member 35 includes the front plate 56 disposed outside of the impact absorbing plate 51. Thus, the numbers of parts and welding spots are respectively reduced to five plates and 14 spot-welding points, in this embodiment.

According to one embodiment of the present invention, the airbag attachment structure comprises: the airbag module 21 for accommodating the airbag body 50 therein, the airbag module 21 having the opening portion 28 from which the airbag body 50 is to protrude, the airbag supporting bracket 23 for holding the airbag module 21 to the back surface of the instrument panel 22. The airbag supporting bracket 23 includes: the rigid guide/reinforcement member 33 capable of reinforcing the airbag supporting bracket 23, covering a part of the circumference of the opening portion 28 defining the uncovered portion, the guide/reinforcement member 33 having the guide portion configured to be inflexible against the airbag body 50 being inflated; the partial guide member 34 which covers the uncovered portion, the partial guide member configured to be flexible against the airbag body 50 being inflated; and the rigid partial reinforcement member 35 which covers the partial guide member 34 from the outside of the partial guide member 34, the partial reinforcement member 35 configured to reinforce the airbag supporting bracket 23.

The present invention further provides an airbag system comprising the airbag attachment structure. Also, the present invention provides a vehicle comprising the airbag attachment structure.

One embodiment of the present invention is described above referring to the drawings, however, the embodiment is illustrated just for an example. Thus, it should be noted that the scope of the present invention should not be limited to the embodiment and can include any variation of the embodiment unless it departs from the sprit of the present invention.

What is claimed is:

1. An airbag attachment structure comprising,
an airbag supporting bracket for holding an airbag module to a back surface of an instrument panel, the airbag supporting bracket comprising a guide portion configured to guide an airbag body inflated out of an opening portion of the airbag module and a reinforcement portion configured to reinforce the airbag supporting bracket,
wherein the airbag supporting bracket further comprises:
a guide/reinforcement member configured to carry both a guide function of the guide portion and a reinforcement function of the reinforcement portion, and cover a circumference of the opening portion of the airbag module, leaving an uncovered portion thereon;
a partial guide member configured to carry only the guide function of the guide portion, the partial guide portion being attached to the uncovered portion; and
a partial reinforcement member configured to carry only the reinforcement function of the reinforcement portion, the partial reinforcement member covering the partial guide member from an outside thereof.

2. The airbag attachment structure according to claim 1, wherein the opening portion of the airbag module has a substantially rectangular shape,
wherein the guide/reinforcement member includes: a back plate disposed along a back surface of the opening portion; and both side plates disposed along both surfaces of the opening portion, the back plate and both of the side plates forming a substantially square U shape as viewed from a top plan,
wherein the partial guide member includes an impact absorbing plate disposed along a front surface to close an open portion of the substantially square U shape of the guide/reinforcement member, and
wherein the partial reinforcement member includes a front plate disposed outside of the impact absorbing plate.

3. An airbag system comprising the airbag attachment structure according to claim 1.

4. A vehicle comprising the airbag attachment structure according to claim 1.

5. An airbag attachment structure, comprising:
an airbag module for accommodating an airbag body therein, the airbag module having an opening portion from which the airbag body is to protrude; and
an airbag supporting bracket for holding the airbag module to a back surface of an instrument panel,
wherein the airbag supporting bracket includes:
a rigid guide/reinforcement member capable of reinforcing the airbag supporting bracket, covering a part of a circumference of the opening portion defining an uncovered portion, the guide/reinforcement member having a guide portion configured to be inflexible against the airbag body being inflated;
a partial guide member which covers the uncovered portion, the partial guide member configured to be flexible against the airbag body being inflated; and
a rigid partial reinforcement member which covers the partial guide member from an outside thereof, the partial reinforcement member configured to reinforce the airbag supporting bracket.

6. An airbag system comprising the airbag attachment structure according to claim 5.

7. A vehicle comprising the airbag attachment structure according to claim 5.
